(19) United States
(12) Patent Application Publication
(10) Pub. No.: US 2019/0089233 A1
(43) Pub. Date: Mar. 21, 2019

(54) METHOD OF FORMING A TWO-PIECE ELECTRIC MOTOR HOUSING

(71) Applicant: BorgWarner Inc., Auburn Hills, MI (US)

(72) Inventor: Attila Nagy, Fishers, IN (US)

(21) Appl. No.: 15/706,065

(22) Filed: Sep. 15, 2017

(51) Int. Cl. H02K 15/14; H02K 5/06; H02K 5/20; B22D 17/00

(52) U.S. Cl. CPC H02K 15/14; B22D 17/002; H02K 5/20; H02K 5/06

(57) ABSTRACT

A method of forming an electric motor housing includes molding an internal housing portion having an outer surface with a mold including two axial mold members and at least one radial mold member, forming an external housing portion including an inner surface section, and installing the internal housing portion into the external housing portion with the outer surface being spaced from the inner surface section by a gap having a selected dimension.

### BACKGROUND OF THE INVENTION

Exemplary embodiments pertain to the art of electric motors and, more particularly, to a method of forming a two-piece motor housing for an electric motor.

Electric motors typically include housing that provides protection and insulation for internal components such as an armature. Often times the housing also provides cooling for the internal components. In some cases, cooling may be accomplished by directing a fluid flow through openings in the housing. In other cases, the fluid flow may be a liquid coolant circulated about the housing. In such cases, the housing is often times formed in multiple pieces that may include an inner housing and an outer housing. A cooling jacket is formed between the inner housing and the outer housing.

In many cases, the outer housing is cast. After casting, the outer housing goes through a machining process that cleans up pathways and the like. The inner housing is machined in order to achieve selected tolerances for a coupling with the outer housing. Machining also promotes formation of the cooling jacket. Machining the inner housing is a time consuming and costly process. Further, machining does not lend itself to high production output given the need to maintain tight tolerances.

### BRIEF DESCRIPTION OF THE INVENTION

Disclosed is a method of forming an electric motor housing including molding an internal housing portion having an outer surface with a mold including two axial mold members and at least one radial mold member, forming an external housing portion including an inner surface section, and installing the internal housing portion into the external housing portion with the outer surface being spaced from the inner surface section by a gap having a selected dimension.

### BRIEF DESCRIPTION OF THE DRAWINGS

The following descriptions should not be considered limiting in any way. With reference to the accompanying drawings, like elements are numbered alike:

FIG. 1 depicts a first side of a two-piece motor housing formed in accordance with an exemplary embodiment;

FIG. 2 depicts another side of the two-piece motor housing of FIG. 1;

FIG. 3 depicts an external housing portion of the two-piece motor housing, in accordance with an aspect of an exemplary embodiment;

FIG. 4 depicts an internal housing portion of the two-piece motor housing, in accordance with an aspect of an exemplary embodiment;

FIG. 5 depicts a partial cross-sectional view of the two-piece motor housing, in accordance with an aspect of an exemplary embodiment; and

FIG. 6 depicts a mold for forming the internal housing member of FIG. 4, in accordance with an aspect of an exemplary embodiment.

### DETAILED DESCRIPTION OF THE INVENTION

A detailed description of one or more embodiments of the disclosed apparatus and method are presented herein by way of exemplification and not limitation with reference to the Figures.

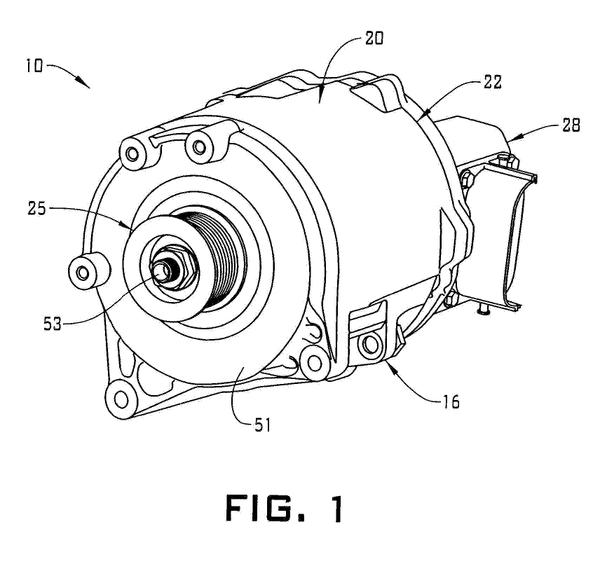

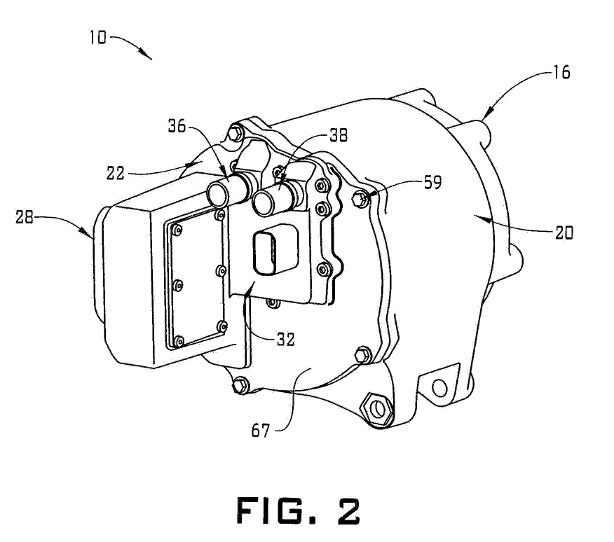

An electric motor, in accordance with an exemplary embodiment, is indicated generally at 10 in FIGS. 1 and 2. Electric motor 10 includes a housing 16 including an external housing portion 20 and an internal housing portion 22. Electric motor 10 includes a pulley 25 that may provide a motive force to other components or, may be receptive of a motive force. Electric motor 10 also includes a connector assembly 28. Connector assembly 28 may be receptive to conductors (not shown) that deliver electrical power to or pass electrical power from electric motor 10. A control connector 32 is also provided on electric motor 10. Control connector 32 may pass status signals from or provide control inputs to electric motor 10. Electric motor 10 is further shown to include a cooling fluid inlet 36 and cooling fluid outlet 38 that facilitate cooling fluid circulation between internal housing portion 22 and external housing portion 20 as will be discussed herein.

With reference to FIG. 3 and continued reference to FIGS. 1 and 2, external housing portion 20 includes an external housing body 44 having an outer surface section 46 and an inner surface section 47 that defines a first cavity 49. First cavity 49 is receptive to internal housing portion 22. External housing body 44 also includes an axial end wall 51 having an opening 52 receptive of a motor shaft 53 (FIG. 1). External housing body 44 is also shown to include a plurality of flow control members 54 that promote cooling fluid circulation as will be discussed herein. Each flow control member 54 includes an external surface section 56. External housing body 44 is further shown to include a number of fastener receiving members, one of which is indicated at 58, which may be internally threaded for receiving a mechanical fastener such as shown at 59 (FIG. 2).

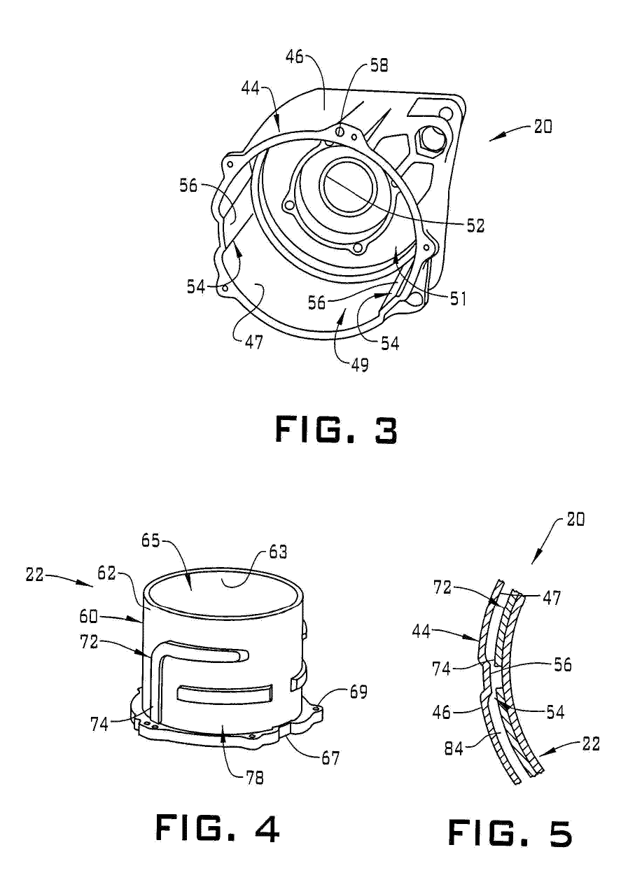

With reference to FIG. 4 and continued reference to FIGS. 1-3, internal housing portion 22 includes an internal housing body 60 having an outer surface 62 and an inner surface 63 that defines a second cavity 65. Second cavity 65 may be receptive of various motor components such as an armature, a stator and the like. Internal housing body 60 includes an axial end wall member 67 having a plurality of openings, one of which is indicated at 69, which align with openings 58 on external housing body 44. Internal housing body 60 includes a plurality of flow control devices 72 each having an external surface portion 74, that cooperate with flow control members 54 on external housing body 44 to form a convoluted flow path 78. Convoluted flow path 78 promotes a passage of cooling fluid between internal housing portion 22 and external housing portion 20 as will be discussed herein.

In accordance with an exemplary embodiment, internal housing body 60 is inserted into first cavity 49 such that a gap 84 is formed between internal housing portion 22 and external housing portion 20 as shown in FIG. 5. In accordance with an exemplary aspect, gap 84 may be between about 0.3-mm and 0.5-mm. Gap 84 may be measured between inner surface section 47 of external housing body 44 and outer surface 62 of internal housing body 60. In accordance with another exemplary aspect, gap 84 may be measured between external surface section 56 of flow control members 54 and outer surface 62. In accordance with yet another exemplary embodiment, gap 84 may be measured between external surface portion 74 of flow control devices 72 and inner surface section 47.

In further accordance with an exemplary embodiment, internal housing body 60 may be installed into first cavity 49 with a slip-fit while maintaining gap 84. Of course, it should be understood that other fits, including an interference fit, may be employed. Once installed, flow control members 54 and flow control devices 72 promote a thermal exchange between the motor components and a cooling fluid circulating between internal housing portion 22 and external housing portion 20. The cooling fluid flows along convoluted flow path 78 from cooling fluid inlet 36 and cooling fluid outlet 38. A portion of the fluid may pass between external surface portion 74 of flow control devices 72 and inner surface section 47 of external housing body 44 bypassing a portion of convoluted flow path 78. The bypassing or blow-by has been shown to maintain desired heat exchange between the motor components and the cooling fluid.

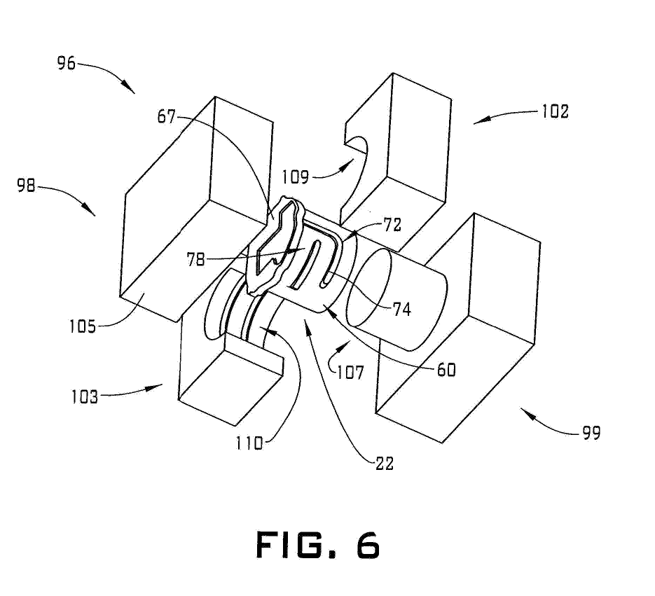

In accordance with an exemplary aspect, internal housing portion 22 is a molded component. In accordance with another exemplary aspect, internal housing portion 22 is die-cast in a mold system 96 such as shown in FIG. 6. Mold system 96 includes at least three components and, in the exemplary embodiment shown, includes at least four components. Specifically, mold system 96 includes a first axial member 98 and a second axial member 99. Mold system 96 also includes a first radial or side member 102 and a second radial or side member 103. First axial member 98 may define a mold 105 including a recess that forms details provided on axial end wall member 67. Second axial member 99 supports a core 107 which forms second cavity 65. First and second radial members 102 and 103 each include corresponding features 109 and 110 that form flow control devices 72.

By forming internal housing portion 22 using mold system 96, manufacturing costs may be reduced. That is, the use of a die-casting process reduces the need for post-production machining in order to obtain selected tolerances between internal housing portion 22 and external housing portion 20. The reduction and, in some cases, the elimination of post-production machining correlates directly with reduced production costs without affecting product reliability.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. A method of forming an electric motor housing comprising:
molding an internal housing portion having an outer surface with a mold including two axial mold members and at least one radial mold member;
forming an external housing portion including an inner surface section; and
installing the internal housing portion into the external housing portion with the outer surface being spaced from the inner surface section by a gap having a selected dimension.

2. The method of claim 1, wherein the selected dimension of the gap between the outer surface and the inner surface section is between about 0.3-mm and 0.5-mm.

3. The method of claim 1, wherein molding the internal housing portion includes die-casting the internal housing portion.

4. The method of claim 1, wherein forming the external housing portion includes casting the external housing portion with a two-piece mold.

5. The method of claim 1, wherein installing the internal housing portion into the external housing portion includes slip-fitting the internal housing portion into the external housing portion.

6. The method of claim 1, wherein molding the internal housing portion includes molding one or more flow control devices onto the outer surface.

7. The method of claim 6, wherein forming the external housing portion includes molding one or more flow control members onto the inner surface section, the one or more flow control members cooperating with the one or more flow control devices to form a fluid flow path between the internal housing portion and the external housing portion.

8. The method of claim 7, wherein the gap is defined between at least one of the inner surface section and an external surface portion of the one or more flow control devices, and the outer surface and an external surface section of the one or more flow control members.

9. The method of claim 1, wherein molding the internal housing portion includes die-casting the internal housing portion with a four-piece mold, wherein the at least one radial mold portion includes at least two radial mold portions.

10. The method of claim 1, wherein molding the internal housing portion includes molding a fluid inlet and a fluid outlet on an axial end wall of the internal housing portion.

11. The method of claim 1, further comprising: securing the internal housing portion to the external housing portion with a plurality of mechanical fasteners.
